(19) United States
(12) Patent Application Publication
(10) Pub. No.: US 2009/0320340 A1
(43) Pub. Date: Dec. 31, 2009

(54) Illuminated road sign and a method for illuminating a road sign

(75) Inventor: Dror Koren, Kfar Saba (IL)

Correspondence Address: Pearl Cohen Zedek Latzer, LLP, 1500 Broadway, 12th Floor, New York, NY, 10036, US

(73) Assignee: Panel El Ltd, Ra'anana (IL)

(21) Appl. No.: 12/164,141

(22) Filed: Jun. 30, 2008

(51) Int. Cl. G09F 13/22

(52) U.S. Cl. 40/544

(57) ABSTRACT

An illuminated road sign, that includes: a supporting element, a front element, and multiple electroluminescent lamps located between the supporting element and the front element; wherein the front element comprises multiple regions, wherein at least one region is defined by a translucent reflecting element; wherein the electroluminescent lamps are shaped and placed according to the multiple regions; wherein the electroluminescent lamps are adapted to blink, during at least one blinking period.

### RELATED APPLICATIONS

This application claims priority from Israeli patent application, ‘Illuminated road sign and a method for illuminating a road sign’ filed on 25 Jun. 2008 in the Israeli Patent Office.

### FIELD OF THE INVENTION

This application related to an illuminated road sign and a method for illuminating a road sign.

### BACKGROUND OF THE INVENTION

Many accidents can be attributed to the lack of visibility of traffic signs. Traffic signs are expected to be visible during a large variety of light conditions but various prior art solutions for providing adequate visibility have proven to be unsatisfactory.

PCT patent application WO 200048166 describes an illuminated, solar powered, vehicle activated, traffic sign that includes a front lens having a sign legend; an electroluminescent panel disposed behind the lens to provide lighting to the sign legend; a power source operably connected to the electroluminescent panel; a first sensor responsive to the headlights of an approaching vehicle and connected to the electroluminescent panel to activate the electroluminescent panel upon detection of the headlights; and a second sensor responsive to ambient light and connected to the electroluminescent panel such that the electroluminescent panel is OFF during daylight.

US patent application 20040244246 provides an illuminated road sign that has a long lifetime by providing an illuminated road sign that includes multiple elements of electroluminescent material, and by activating only one out of these elements at a time (for example, during alternate nights) or using one electroluminescent material as a backup in case another electroluminescent material fails.

Great Britain patent application GB2395838 describes an electroluminescent display that has an electroluminescent layer formed of a phosphor layer between electrode layers which are connectable to a power source. The display also has a reflective material. The display may include a compensator to compensate for decreases in emitted light over time. The display may be activated by sound, temperature, pressure, light level, moisture, motion or a timer. The reflective material may be patterned. The display may be used as a road sign, safety indicator, vehicle number plate, warning sign, or for advertising.

Great Britain patent application GB2405022 A1 describes a traffic sign that has a multi-layered structure that includes a front panel and a rear panel that is attached to the back of the front panel. The front panel bears a sign content having visually distinctive regions, at least one of which is light transmissive. The rear panel has an active light illuminating layer, and a reflective layer. In one embodiment the sign is used as a vehicle license/registration plate, and in a further embodiment the sign is used as a road sign. The light illuminating layer is preferably electroluminescent, and the reflective layer is preferably a wide angle prismatic layer. The light illuminating layer may also comprise a honeycomb arrangement of apertures allowing incident light to pass through and strike the reflective layer.

Korean patent application describes a road sign plate having a lighting apparatus is provided to enhance the driver's visibility by adding backlighting function for lighting up a guide note on a road sign plate, to simplify an installation work by using synthetic resins for a road sign plate, to prevent the traffic accident and to reduce the burden on maintenance by enhancing durability and to enable to correct and replace a guide note on a road sign plate rapidly. The road sign plate has a lighting apparatus is composed by attaching a road sign panel to a road sign support installed on the roadside. The road sign panel contains a control unit checking if it's in the daytime or nighttime, then supplying power if it's in the nighttime, a light source lighting by the operating voltage of the control unit, a light guide plate shooting and dispersing beam irradiated from the light source to form an electroluminescent lamp, a reflective plate reflecting the beam of the electroluminescent lamp by the light guide plate in one way, a replaceable letter plate installed to the opposite side to the reflective plate and using an electroluminescent lamp formed by the light guide plate as backlight, and a protective plate installed on the letter plate to protect the letter plate.

PCT patent application WO 200195294 describes an apparatus in the form of a light element made from an electroluminescent material that is applied in any desired configuration or pattern onto a backing, the backing being optionally selectively mountable and dismountable on any suitable mounting base, such as a traffic cone.

U.S. Pat. No. 4,857,920 describes a highly reliable and economical traffic signal has only one light-emitting display section having two or more semiconductor thin-film EL plates of different colors such as green and red stacked one on top of the other. Green and red can be displayed by causing one of the EL plates to emit light and yellow can be displayed by causing both of them to emit light.

European patent application EP1622110 describes an electroluminescent illuminated sign that include at least one electroluminescent sheet powered by an alternating voltage generator, and at least one support for an image to be lit, placed on the top of the electroluminescent sheet, on which support the image to be lit contrasts with the remaining surface of the support so that when the support is placed over the electroluminescent sheet only the image stands out.

U.S. Pat. No. 7,048,400 of Murasko el at., describes an integrated illumination systems employing illumination devices formed onto substrates. The display system combines an electroluminescent lamp, a photocell, a power supply receiving energy from the photocell and discharging electrical energy to the EL lamp, and, optionally, a control switch to manage the intervals of electrical energy discharge to the EL lamp for illumination. These components are combined to provide illumination for an object, such as a sign. A photocell, power supply and light emitting device are each formed onto a single substrate to form a totally self-contained, self-powered illuminating device. An electroluminescent lamp (EL) is provided to form an illuminated decal. The EL lamp has a front illumination surface and a back mounting surface, with a decal backing attached to the back mounting surface. The decal backing is configured to be affixed to various objects, such as vehicles, to provide an illumination source thereon. Alternatively, a magnetic material may be affixed to the back mounting surface of the EL lamp to replace the decal backing.

The EL lamp of Murasko can include: (i) a substrate, (ii) a transparent front electrode formed on substrate back surface, (iii) a light emitting layer formed on the transparent front electrode, (iv) a dielectric layer that is used if an electroluminescent phosphor is used for the light emitting layer, (v) a rear electrode that is formed on the light emitting layer. If the optional dielectric layer is provided, the rear electrode is formed on such dielectric layer, and (vi) a protective coating layer that may be an ultraviolet (UV) coating. Each of the component layers of the EL lamp may be successively applied onto the substrate by a variety of means, including stenciling, flat coating, brushing, rolling, and spraying, but preferably are printed onto the substrate by screen or ink jet printing.

These EL lamp components may be made from the following materials: (i) the transparent front electrode may be fabricated from organics, such as polyaniline, polypyrrole, poly-phenyleneamine-imine, and polyethylene-dioxithiophene, or inorganics, such as indium-tin-oxide; (ii) the light emitting layer may be fabricated from organics, such as light-emitting polymers/organic light emitting diodes, or non-organics, such as phosphor layer of electroluminescent particles, e.g., zinc sulfide doped with copper or manganese which are dispersed in a polymeric binder; (iii) the dielectric layer of high dielectric constant material such as barium titanate; and (iv) the rear electrode may be fabricated from organics, such as polyaniline, polypyrrole, poly-phenyleneamine-imine, and polyethylene-dioxithiophene, which is available under the trade name “Orgacon” from Agfa Corp. of Ridgefield Park, N.J., or inorganics, such as silver or carbon particles dispersed in a polymeric ink.

The light emitting layer of Murasko can be made of a light emitting polymer that requires low voltage for operation, typically about 10 volts or less. The background layer can have certain transparent and optically opaque areas formed by, for example, colored printable inks, can be formed onto assembly substrate back surface prior to the EL lamp being formed thereon and at a location where EL lamp is to be positioned. Such a background layer may form a specific illuminated design made into the shape of illuminated images (e.g., wording, logos, icons, etc.). Additionally, illuminated images can be formed by positioning the light emitting layer of the EL lamp in the form of such images.

The EL lamp of Murasko can be connected to leads that electrically connect a power supply to the EL lamp to bring electrical energy to the EL lamp. One lead can be connected to the front and rear electrodes of the lamp. One lead can include a front outlining electrode lead configured to substantially surround and electrically contact the transparent front electrode of the EL lamp, and a rear electrode lead can be configured to electrically contact the rear electrode of the EL lamp. The EL lamp can receive power during night and deactivated during the day.

There is a need for providing highly visible road signs.

### SUMMARY

A highly visible illuminated road sign is provided. It combines a translucent reflecting element and multiple electroluminescent lamps that can be activated in a high frequency alternating manner to provide a blinking effect.

The illuminated road sign can include a supporting element, a front element, and multiple electroluminescent lamps located between the supporting element and the front element. The front element comprises multiple regions, wherein at least one region is defined by a translucent reflecting element. The electroluminescent lamps are shaped and placed according to the multiple regions. The electroluminescent lamps are adapted to blink, during at least one blinking period.

A method for illuminating a road sign is provided, the method includes: determining to start a blinking period; and causing multiple electroluminescent lamps of the road sign to blink, during the blinking period; wherein the multiple electroluminescent lamps are located between a supporting element and a front element of the road sign; wherein the front element includes multiple regions, wherein at least one region is defined by a translucent reflecting element; and wherein the electroluminescent lamps are shaped and placed according to the multiple regions.

The blinking frequency of the electroluminescent lamps can be defined so as to attract an attention of a user.

The blinking frequency of the electroluminescent lamps can exceed 1 hertz.

The at least one blinking period can occur when ambient light is below a threshold.

The multiple electroluminescent lamps can be formed in a thin electroluminescent layer.

Each electroluminescent lamp can be shaped such as to match a region defined by a translucent reflecting element.

The illuminated road sign can include a power unit that includes a solar panel, a rechargeable battery, a rechargeable battery controller, a power network interface and a power converter.

The illuminated road sign can include a control unit that controls an activation of the multiple electroluminescent lamps.

The translucent reflecting element can be a diamond grate translucent DG reflective sheet element.

At least one region of the front element can be a letter.

At least two luminescent lamps can concurrently blink, during the at least one blinking period.

At least two luminescent lamps can blink in a non-overlapping manner, during the at least one blinking period.

At least two luminescent lamps can blink in a partially overlapping manner, during the at least one blinking period.

The method can include starting a blinking period when ambient light is below a threshold.

The method can include providing power to the multiple electroluminescent lamps by a power unit that comprises a solar panel, a rechargeable battery, a rechargeable battery controller, a power network interface and a power converter.

The method can include controlling, by a control unit, an activation of the multiple electroluminescent lamps.

The method can include reflecting light directed from other objects towards the illuminated sign by a translucent reflecting element is a diamond grate translucent DG reflective sheet element.

The method can include causing at least two luminescent lamps to concurrently blink, during the blinking period.

The method can include causing at least two luminescent lamps to blink in a non-overlapping manner, during the blinking period.

The method can include causing at least two luminescent lamps to blink in a partially overlapping manner, during the blinking period.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIG. 1A illustrates a portion of an illuminated road sign according to an embodiment of the invention;

FIG. 1B illustrates an illuminated road sign according to an embodiment of the invention;

FIG. 2 illustrates multiple layers that form illuminated road sign according to an embodiment of the invention;

FIG. 3 illustrates two illuminated road signs and additional structural elements according to an embodiment of the invention;

FIG. 4 illustrates an illuminated road sign according to an embodiment of the invention;

FIG. 5 illustrates various components of an illuminated road signs according to an embodiment of the invention;

FIG. 6 illustrates a method for illuminating a road sign according to an embodiment of the invention; and

FIGS. 7A-7C are timing diagrams according to various embodiments of the invention.

### DETAILED DESCRIPTION OF THE INVENTION

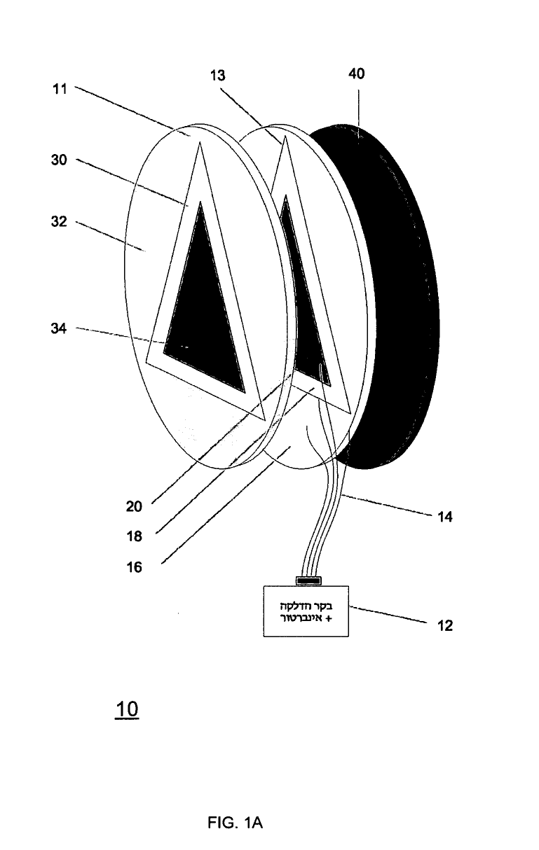

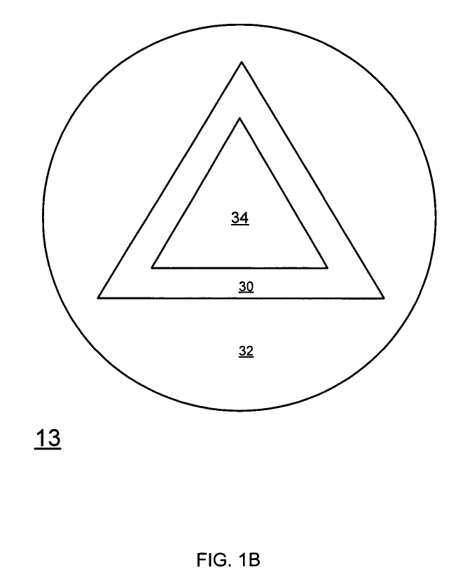

FIG. 1A is an exploded view of illuminated road sign 10 according to an embodiment of the invention. FIG. 1B is a view of layer 13 according to an embodiment of the invention.

Illuminated road sign 10 includes a circular supporting element 40, a circular layer 13 of electroluminescent lamps that includes electroluminescent lamps 16, 18 and 20, and front element 11 that include translucent reflecting element 30 that divides the circular shaped illuminated road sign 10 to three regions—an inner triangular region 34 that is surrounded by translucent reflecting element 30, a triangular shaped frame formed by the translucent reflecting element 30 itself and an outer region 32 located between the perimeter of front element 11 and the external edges of translucent reflecting element 30.

A partially transparent colored element of front element 11 is located within the inner triangular region 34 defined by translucent reflecting element 30.

Electroluminescent lamp 16 is shaped to match outer region 32. Electroluminescent lamp 18 is shaped to match the triangular shaped frame formed by the translucent reflecting element 30 itself. Electroluminescent lamp 20 is shaped to match triangular region 34.

It is noted that each of these regions can be associated with multiple (conveniently non-overlapping) electroluminescent lamps.

It is further noted that not each region is necessarily associated with an electroluminescent lamp.

An electroluminescent lamp conveniently illuminates only its corresponding region while not illuminating other regions (especially those distant from that electroluminescent lamp). Conveniently, one electroluminescent lamp can be a backup to another failed electroluminescent lamp.

Wires 14 connect each of electroluminescent lamps 16, 18 and 20 to control unit 12 that controls the operation of these electroluminescent lamps and especially causes these electroluminescent lamps to blink.

Circular supporting element 40 is made of durable material and can be connected to poles or other structural elements that connect illuminated road sign 10 to the ground, to other structural elements such as road blocks, traffic cones, barrier boards, t-top bollards, automatic gates and the like.

It is noted that the illuminated road sign can be of different shapes, such as but not limited to a rectangular shape, an octagonal shape, diamond shape, rectangular shape and the like.

It is noted that while the translucent reflecting element 30 can define one or more regions, the front element can define one or more other regions by other means. For example, colored portions of the front element can also define one or more regions.

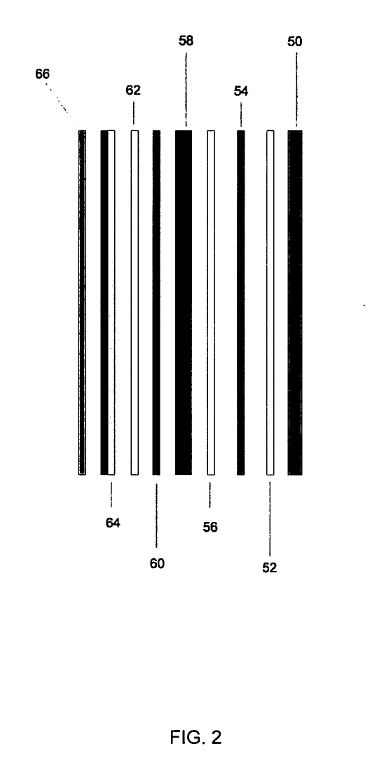

FIG. 2 illustrates multiple layers that form illuminated road sign 10 according to an embodiment of the invention.

These layers include: supporting layer 50, insulating layer 52, back electrode layer 54, dielectric layer 56, phosphorous layer 58, transparent front electrode layer 60, insulating layer 64, front layer 64 and upfront layer that can include an ultraviolet protective coating and color portion that is shaped to match inner region 34. The aggregate thickness of these layers is about 2.5 millimeters, wherein about 1.5 millimeters are attributed to supporting layer 50 and to insulating layer 52.

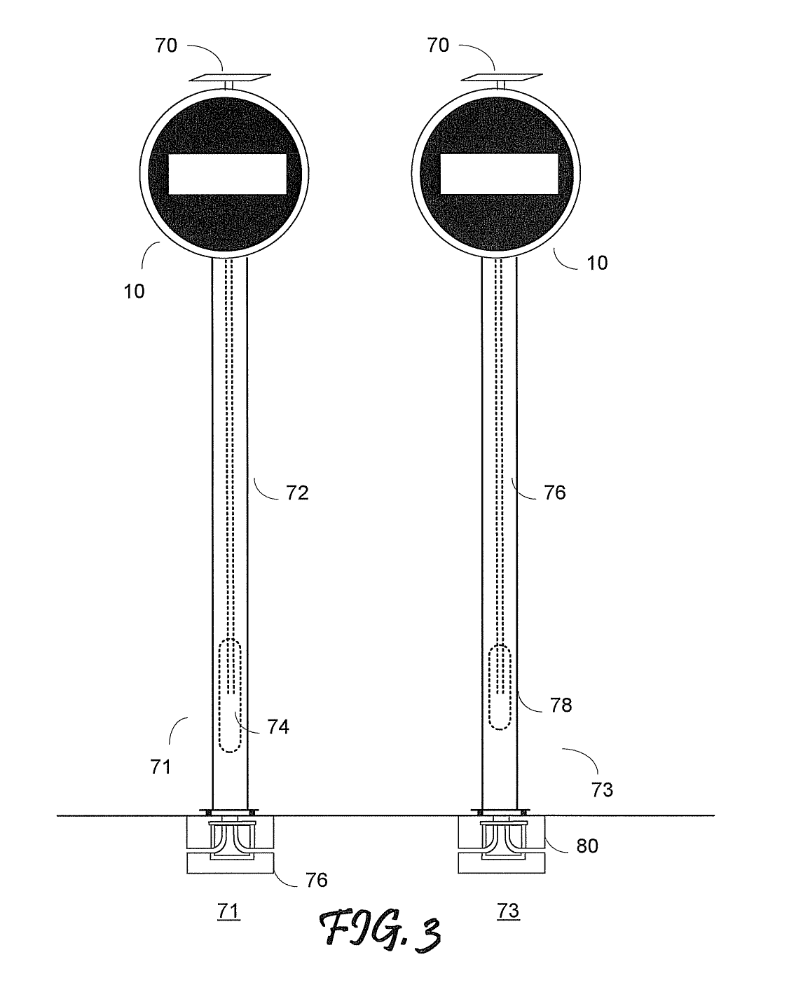

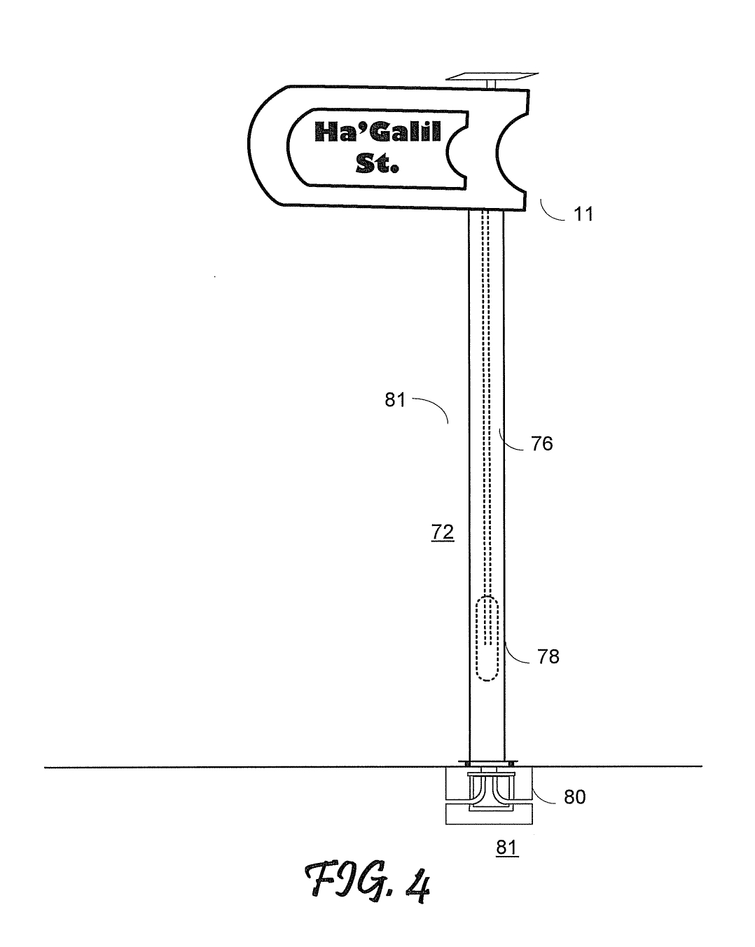

FIGS. 3 and 4 illustrate various road signs 71, 73 and 81 that include portion 10 as well as a pole (72, 76), a connectivity compartment (74, 78), solar panel 70 and an underground electrical infrastructure (76,80) that enables these illuminated road signal to receive power from an underground electrical power grid.

Supporting element 40 can be connected to such poles or other structural elements by various manners, including but not limited to gluing, welding, using screws and the like.

Referring back to FIG. 1A, electroluminescent lamps 16, 18 and 20 can receive control signals (via wires 14) that cause them to blink, during at least one blinking period.

It has been shown that the human eye is sensitive to blinking signals. The blinking frequency of electroluminescent lamps 16, 18 and 20 can be set to attract an attention of a user.

The blinking frequency of the electroluminescent lamps can exceed 1 hertz. It should be low enough so that the human eye will not interpret the blinking as a continuous light pattern.

Conveniently, the at least one blinking period occurs when ambient light is below a threshold. Thus, if the ambient light is strong enough and the blinking will not be effectively noticed, electroluminescent lamps 16, 18 and 20 can be shut off, in order to lengthen their lifespan and to save energy.

The ambient light can be sensed by a light sensor, can be evaluated from the conductance of the electroluminescent lamps. Additionally or alternatively, a timer can be used in order to initiate a blinking period. The timer can be set to enable a blinking period during the night, during certain hours, and the like.

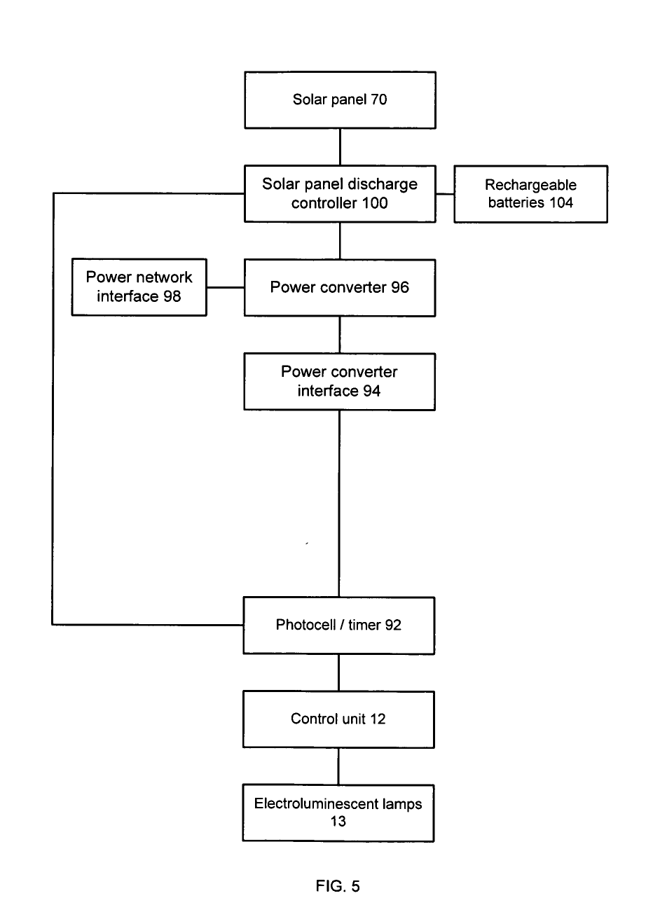

FIG. 5 illustrates various components 10, 12, 92, 94, 96, 98, 100, 70 and 104 of an illuminated road signs according to an embodiment of the invention.

Portion 10 receives power from control unit 12. Control unit 12 is connected to a photocell/timer 92 that can enable a blinking period. Photocell/timer 92 can receive power from solar panel discharge controller 100, and additionally or alternatively, from power converter interface 94. Solar panel discharge controller 100 is connected to solar panel 70 and to rechargeable batteries 104. It can determine when and how to charge rechargeable batteries 104 and when and who to provide solar panel generated power to photocell/timer 92.

Power converter interface 94 receives power from a power converter 96 that receives power, via power network interface 98, from a power network. The power network can be an underground power network. Power network interface 98 of FIG. 5 can be included within underground electrical infrastructure 76 or 80 of FIGS. 3 and 4.

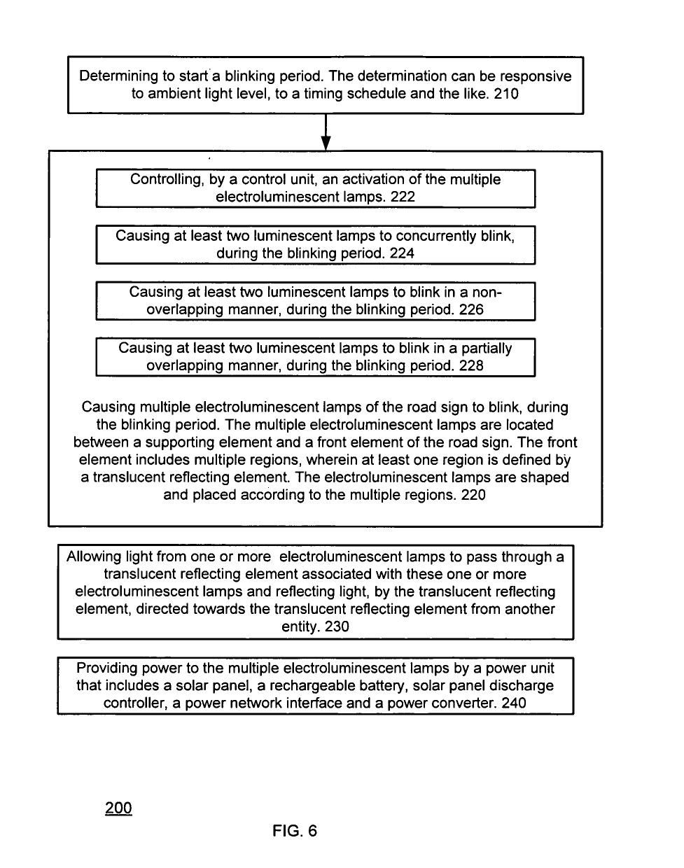

FIG. 6 illustrates method 200 for illuminating a road sign according to an embodiment of the invention.

Method 200 starts by stage 210 of determining to start a blinking period. The determination can be responsive to ambient light level, to a timing schedule and the like.

Stage 210 is followed by stage 220 of causing multiple electroluminescent lamps of the road sign to blink, during the blinking period. The multiple electroluminescent lamps are located between a supporting element and a front element of the road sign. The front element includes multiple regions, wherein at least one region is defined by a translucent reflecting element. The electroluminescent lamps are shaped and placed according to the multiple regions.

Method 200 also includes stage 230 of allowing light from one or more electroluminescent lamps to pass through a translucent reflecting element associated with these one or more electroluminescent lamps and reflecting light, by the translucent reflecting element, directed towards the translucent reflecting element from another entity.

Method 200 can include stage 240 of providing power to the multiple electroluminescent lamps by a power unit that includes a solar panel, a rechargeable battery, solar panel discharge controller, a power network interface and a power converter.

Stage 220 includes at least one of the following stages: (i) stage 222 of controlling, by a control unit, an activation of the multiple electroluminescent lamps; (ii) stage 224 of causing at least two luminescent lamps to concurrently blink, during the blinking period; (iii) stage 226 of causing at least two luminescent lamps to blink in a non-overlapping manner, during the blinking period; and (iv) stage 228 of causing at least two luminescent lamps to blink in a partially overlapping manner, during the blinking period.

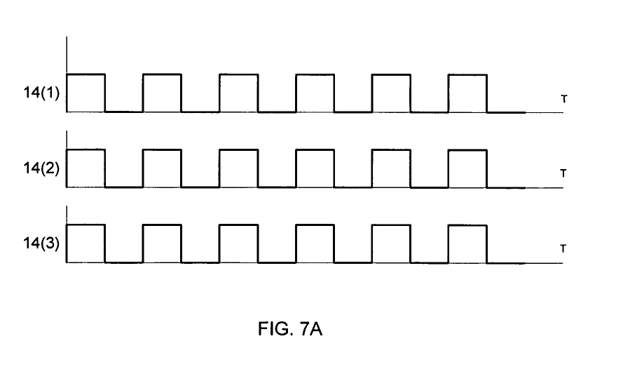

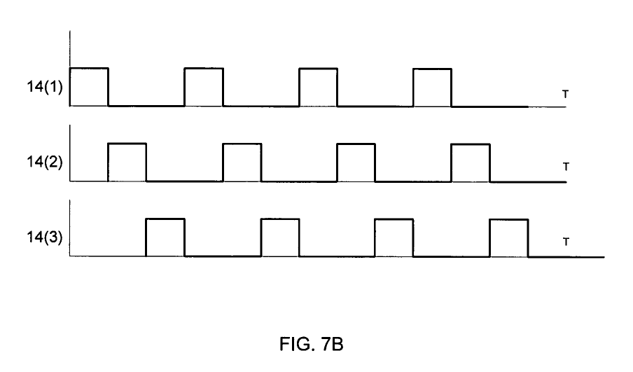

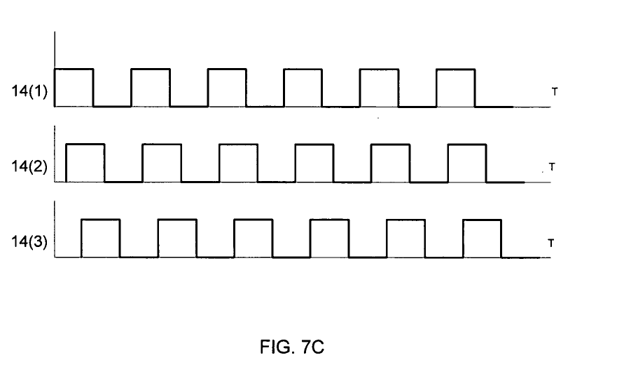

FIGS. 7A-7C are timing diagrams according to various embodiments of the invention.

FIG. 7A illustrates a concurrent activation of electroluminescent lamps 16, 18 and 20, as illustrated by control signals 14(1), 14(2) and 14(3) that activate these electroluminescent lamps. It is assumed that an electroluminescent lamp is activated (lighted on) once a corresponding control signal is asserted, although this is not necessarily so.

Although not illustrated in FIG. 7A, two out of these three electroluminescent lamps can be activated concurrently while the third electroluminescent is activated in a non-concurrent manner to these two electroluminescent lamps.

FIG. 7B illustrates a non-overlapping activation of electroluminescent lamps 16, 18 and 20, as illustrated by control signals 14(1), 14(2) and 14(3) that activate these electroluminescent lamps. At each given point of time (within the blinking period) up to a single electroluminescent lamp is activated.

FIG. 7C illustrates a partially overlapping activation of electroluminescent lamps 16, 18 and 20, as illustrated by control signals 14(1), 14(2) and 14(3) that activate these electroluminescent lamps.

The present invention can be practiced by employing conventional tools, methodology, and components. Accordingly, the details of such tools, component, and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

1. An illuminated road sign, comprising:
a supporting element, a front element, and multiple electroluminescent lamps located between the supporting element and the front element;
wherein the front element of the illuminated road sign comprises multiple regions, wherein at least one of the regions is an inner region that is surrounded by a translucent reflecting element;
wherein the front element further comprises a partially transparent colored element that is located within the inner region;
wherein the electroluminescent lamps are shaped and placed according to the multiple regions; and
wherein the electroluminescent lamps are adapted to blink, during at least one blinking period.

2. The illuminated road sign according to claim 1 wherein a blinking frequency of the electroluminescent lamps is defined so as to attract an attention of a user.

3. The illuminated road sign according to claim 1 wherein a blinking frequency of the electroluminescent lamps exceeds 1 hertz.

4. The illuminated road sign according to claim 1 wherein the at least one blinking period occur when ambient light is below a threshold.

5. The illuminated road sign according to claim 1 wherein the multiple electroluminescent lamps are formed in a thin electroluminescent layer.

6. The illuminated road sign according to claim 1 wherein each electroluminescent lamp is shaped such as to match a region defined by a translucent reflecting element.

7. The illuminated road sign according to claim 1 comprising a power unit that comprises a solar panel, a rechargeable battery, solar panel discharge controller, a power network interface and a power converter.

8. The illuminated road sign according to claim 1 comprising a control unit that controls an activation of the multiple electroluminescent lamps.

9. The illuminated road sign according to claim 1 wherein a translucent reflecting element is a diamond grate translucent DG reflective sheet element.

10. (canceled)

11. The illuminated road sign according to claim 1 wherein at least two luminescent lamps concurrently blink, during the at least one blinking period.

12. The illuminated road sign according to claim 1 wherein at least two luminescent lamps blink in a non-overlapping manner, during the at least one blinking period.

13. The illuminated road sign according to claim 1 wherein at least two luminescent lamps blink in a partially overlapping manner, during the at least one blinking period.

14. A method for illuminating a road sign, the method comprises:
determining to start a blinking period; and
causing multiple electroluminescent lamps of the road sign to blink, during the blinking period; wherein the multiple electroluminescent lamps are located between a supporting element and a front element of the road sign; wherein the front element of the road sign comprises multiple regions, wherein at least one of the regions is an inner region that is surrounded by a translucent reflecting element; wherein the front element further comprises a partially transparent colored element that is located within the inner region; and wherein the electroluminescent lamps are shaped and placed according to the multiple regions.

15. The method according to claim 14 wherein a blinking frequency of the electroluminescent lamps is defined so as to attract an attention of a user.

16. The method according to claim 14 wherein a blinking frequency of the electroluminescent lamps exceeds 1 hertz.

17. The method according to claim 14 comprising to start a blinking period when ambient light is below a threshold.

18. The method according to claim 14 wherein the multiple electroluminescent lamps are formed in a thin electroluminescent layer.

19. The method according to claim 14 wherein each electroluminescent lamp is shaped such as to match a region defined by a translucent reflecting element.

20. The method according to claim 14 comprising providing power to the multiple electroluminescent lamps by a power unit that comprises a solar panel, a rechargeable battery, solar panel discharge controller, a power network interface and a power converter.

21. (canceled)

22. The method according to claim 14 comprising reflecting light directed from other objects towards the illuminated sign by a translucent reflecting element is a diamond grate translucent DG reflective sheet element.

23. The method according to claim 14 wherein at least one region is a letter.

24. The method according to claim 14 comprising causing at least two luminescent lamps to concurrently blink, during the blinking period.

25. The method according to claim 14 comprising causing at least two luminescent lamps to blink in a non-overlapping manner, during the blinking period.

26. The method according to claim 14 comprising causing at least two luminescent lamps to blink in a partially overlapping manner, during the blinking period.

27. The illuminated road sign according to claim 4, wherein the ambient light is evaluated from the conductance of the electroluminescent lamps.

28. The method according to claim 17, further comprising evaluating the ambient light from the conductance of the electroluminescent lamps.

29. The illuminated road sign according to claim 1, wherein the supporting element can be coupled to external structural elements by welding.

30. The illuminated road sign according to claim 1, wherein the supporting element can be coupled to external structural elements by screws.
